(19) United States
(12) Patent Application Publication
(10) Pub. No.: US 2025/0391283 A1
(43) Pub. Date: Dec. 25, 2025

(54) VIRTUAL ENVIRONMENT FOR DYNAMICALLY MODIFIED STORYLINES

(71) Applicant: International Business Machines Corporation, Armonk, NY (US)

(72) Inventors: Sarbajit Kumar Rakshit, KOLKATA (IN); Natalie Brooks Powell, Bolingbrook, IL (US); Santosh Rajashekar, Bangalore (IN)

(21) Appl. No.: 18/751,332

(22) Filed: Jun. 23, 2024

(51) Int. Cl. G09B 5/06; G06T 11/00

(52) U.S. Cl. CPC G09B 5/065; G06T 11/00

(57) ABSTRACT

Techniques are described with respect to a system, method, and computer program product for dynamically creating virtual learning environments. An associated method includes analyzing plurality of users associated with a virtual environment; determining a plurality of contextual information based on respective geographic locations of the plurality of users; and adjusting the virtual environment based on the determination; wherein adjusting comprises monitoring a plurality of interactions of the plurality of users with the virtual environment based on the plurality of contextual information.

### FIELD

This disclosure relates generally to virtual, augmented, mixed, and/or extended reality computing systems and more particularly to dynamically rendering modifiable storylines for virtual environments designated for cultural learning.

### BACKGROUND

Modern technologies such as, but not limited to virtual reality (VR), augmented reality (AR), mixed reality (MR), and/or extended reality (XR) have removed barriers regarding communications among individuals by providing enhancement of user perception of a real-world environment through superimposition of a digital overlay in a display interface providing a view of such environment. However, the aforementioned rendered environments need to account for cultural-related disparities among users associated with various geographic locations. For example, the cultural and societal norms for a first user from a first geographic location may starkly contrast those of a second user in a second geographic location in which the applicable virtual environment must be dynamically adapted to facilitate an optimized experience for all parties involved so that users can not only learn about other cultures, but also refine their behavior in the shared virtual environment accordingly.

### SUMMARY

Additional aspects and/or advantages will be set forth in part in the description which follows and, in part, will be apparent from the description, or may be learned by practice of the invention.

Aspects of an embodiment of the present invention disclose a method, system, and computer program product for dynamically creating virtual learning environments. In some embodiments, analyzing a plurality of users associated with a virtual environment; determining a plurality of contextual information based on respective geographic locations of the plurality of users; and adjusting the virtual environment based on the determination; wherein adjusting comprises monitoring a plurality of interactions of the plurality of users with the virtual environment based on the plurality of contextual information.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a dynamic virtual environment for cultural learning system environment, according to an exemplary embodiment;

FIG. 3 illustrates a block diagram of various modules associated with a virtual reality module and a cultural context module of the system FIG. 2, according to an exemplary embodiment;

FIG. 4 illustrates avatars engaged in a dynamic virtual environment for cultural learning based on a first culture, according to an exemplary embodiment;

FIG. 5 illustrates the avatars engaged in the dynamic virtual environment for cultural learning based of FIG. 4 on a second culture, according to an exemplary embodiment; and

FIG. 6 illustrates an exemplary flowchart depicting a method for creating dynamic virtual environments for cultural learning, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for dynamically creating virtual learning environments. Virtual and/or internet-based platforms have become widespread means for international communications, dissemination of culture, and the like, in which content is dynamically tailored based on the preferences of the applicable user(s). In particular, virtual environments operated by VR, AR, MR, and/or XR systems provide instances of cultural and/or social exchanges across mass audiences. However, social and/or cultural expectations, standards, etc. may be different across users in various geographic locations; thus, creating cultural barriers, predispositions, awareness, and the like among users. Therefore, the present embodiments have the capacity to provide a system not only configured to dynamically generate virtual environments that conform to the cultural and social expectations of users dispersed across various geographic locations, but also create cultural-related avatars designed to interact with users for the purpose of dynamically rendering virtual environments that rectify cultural and societal disparities across the masses. Furthermore, the present embodiments have the capacity to utilize machine learning models, such as but not limited to Large Language Models (LLMs) to construct cultural-related storylines for interactive depictions within virtual environments that showcase specific cultural elements and provide further opportunities for observational learning for users.

As described herein a “virtual avatar” is a cognitive anthropomorphic virtual object rendered via computer animation/graphics configured to interact with virtual environments for the purpose of not only providing a user the cognitive computing capabilities including to see, to hear, to communicate, to move, etc. within virtual environments, but also serving as virtual assistants/chatbots for the user to interact with within virtual environments that support embedded cognitive computing capabilities including but not limited to natural language dialogue, user recognition, artificial intelligence techniques, cultural-related coaching, and the like. In a preferred environment, virtual avatars are depicted within virtual, augmented, mixed, and/or extended reality-based environments, in which virtual reality (“VR”) refers to a computing environment configured to support computer-generated objects and computer mediated reality incorporating visual, auditory, and other forms of sensory feedback. Augmented reality (“AR”) is technology that enables enhancement of user perception of a real-world environment through superimposition of a digital overlay in a display interface providing a view of such environment. For instance, augmented reality can provide respective visualizations of various layers of information relevant to displayed real-world scenes.

As described herein “monitoring” refers to utilizing artificial intelligence-based mechanisms to continuously learn and apply applicable data designed to instruct cultural-specific contexts, fill cultural gaps, knowledge gaps, socially-relevant gaps, and the like related to users interacting with one or more virtual avatars and/or other users in virtual environments. Furthermore, ascertaining contextual information comprises processing, analyzing, and applying one or more cultural and societal forms of speech, actions, and/or customs associated with users allocated across multiple geographic locations.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

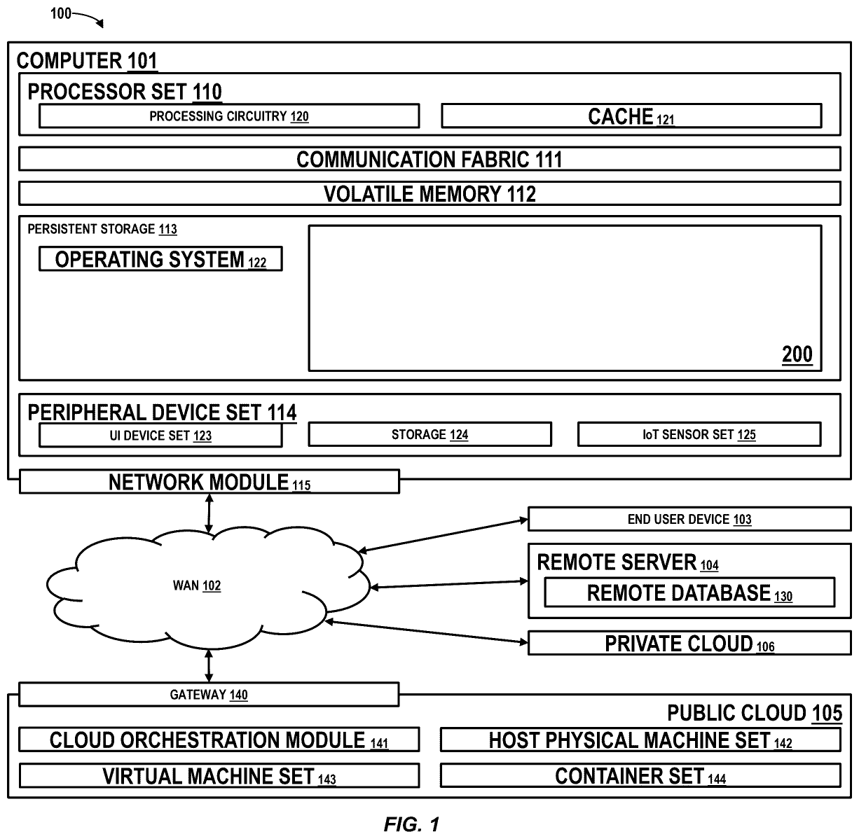

The following described exemplary embodiments provide a system, method, and computer program product for dynamically creating virtual learning environments. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

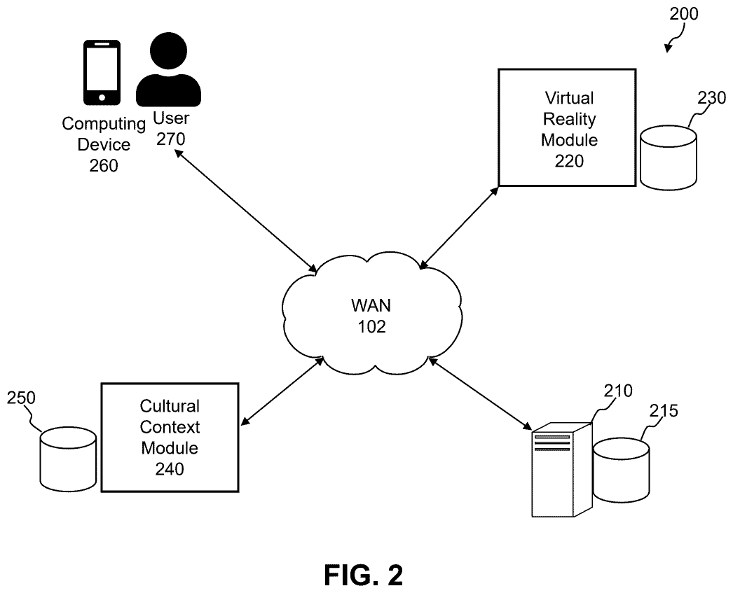

Referring now to FIG. 2, a functional block diagram of a networked computer environment illustrating a computing environment for dynamic virtual environment for cultural learning system 200 (hereinafter “system”) comprising a server 210 communicatively coupled to a database 215, a virtual reality module 220 communicatively coupled to a virtual reality module database 230, a cultural context module 240 communicatively coupled to a cultural context module database 250, and a computing device 260 associated with a user 270, each of which are communicatively coupled over WAN 102 (hereinafter “network”) and data from the components of system 200 transmitted across the network is stored in database 215.

In some embodiments, server 210 is configured to operate a centralized platform serving as a cloud-based virtual environment analyzer and virtual environment rendering assistance platform. Server 210 is configured to provide a mechanism of user 270 to not only view metrics, analytics, key performance indicators, etc. associated with virtual environments such as operating metaverses and instances therein (e.g., virtual objects, themes, interactions), but also provide one or more user interfaces and application programming interfaces (APIs) to computing device 260 allowing user 270 to select preferences and the like associated with virtual objects, themes, visualizations, and the like. It should be noted that system 200 is configured to support navigating nuances of workflows within virtual environments whether culturally, socially, educationally, etc. User activity, historical behavior, interactions with virtual environments, user feedback, etc. of user 270 allow for system 200 to allow virtual reality module 220 with not only rendering virtual environments, but more importantly dynamically modifying virtual environments to account for geographic location specific customs, cultural/micro-cultural awareness, social awareness, skills specific to the applicable virtual environment (e.g., cultural barrier exercises, aptitude of learning materials, requirements to achieve success, etc.), mannerisms and characteristics of user 270, reactions of other users to interactions of user 270, and any other applicable type of necessary dynamical virtual environment modification known to those of ordinary skill in the art. Additionally, server 210 may utilize one or more web crawlers to search and obtain relevant cultural/societal information associated with applicable geographic regions and store said information in database 215 allowing that allows for real-time dynamic modifications of virtual environments comprising the full spectrum of features associated with virtual environment themes, avatar physical appearance, vocal characteristics/dialect, VR/AR functionality/capabilities, and the like.

Virtual reality module 220 is configured to generate virtual environments in addition to analyze virtual environments for subsequent dynamic modifications based on data ascertained from cultural context module 240. Applicable data that the virtual environments may be modified based on include, but is not limited to contextual data, geographic data associated with applicable users and data sources, avatar data, expertise data, share learning insights, user reactions to virtual elements (e.g., virtual objects, digital avatars, etc.), event data associated with events occurring within virtual environments, and the like. The aforementioned data may be ascertained by virtual reality module 220 and/or cultural context module 240 for storage in virtual reality module database 230 and/or cultural context module database 250, in which database 215, virtual reality module database 230, and cultural context module database 250 are designed to function as a repositories continuously updated with not only data ascertained by analyses performed by virtual reality module 220 and cultural context module 240, but also other applicable data sources including but not limited to sensors systems associated with virtual environments (e.g., data received by applicable sensors of computing device 260), crowdsourcing platforms, internet based data sources ascertained by web crawlers (e.g., social media platforms), inputs of user 270 provided to the centralized platform, and the like. In some embodiments, contextual factors, parameters, and/or user preferences such as, for example, current weather conditions, a geographical location, physical features and styling, likes and dislikes, user's purchase and/or interest, and the like may be accounted for and taken into consideration when virtual reality module 220 dynamically modifies a virtual environment. It should be noted that contextual data may be associated with the applicable setting, social/societal customs, industry, geographic location, conversation/dialogue of participants, or any other applicable ascertainable contextual-based factors. Virtual reality module 220 may further utilize one or more techniques to analyze virtual environments including, but not limited to, natural language processing (NLP), image analysis, topic identification, virtual object recognition, setting/environment classification, and any other applicable artificial intelligence and/or cognitive-based techniques known to those of ordinary skill in the art.

Cultural context module 240 is configured to ascertain, analyze, and forecast cultural related contextual information associated with virtual environments and virtual elements therein. In addition to an avatar serving as an anthropomorphic representation of user 270 within a virtual environment, the avatar may also function as a manager of computational tasks of machine learning problems and virtual elements of a given virtual environment. In particular, cultural context module 240 comprises a Cultural Affinity Index (CAI), which is a quantitative measure designed to assess the degree of cultural alignment or compatibility between user 270 and other applicable users within a given virtual environment. In addition, the CAI is configured to capture the nuances of cultural differences and similarities in a systematic and comprehensive manner by applying one or more formulas incorporates various dimensions of culture, considering both overt and subtle aspects that influence human interactions including, but not limited to cultural values, communication styles, social norms and etiquette, cultural sensitivity/adaptability, and the like. In some embodiments, cultural context module 240 computes the CAI, in which each of the aforementioned components are assigned a weight reflecting its relative importance in cultural compatibility. For example, computing the CAI between user 270 and an applicable user within the same virtual environment may be CAIAB=Σi=1nWi·SiΣi=1nWiCAIAB=Σi=1nWi Σi=1nWi·Si, in which CAIABCAIAB is the CAI between individuals/groups A and B (i.e., user 270 and other applicable user); WiWi is the weight assigned to component ii; SiSi is the score representing the degree of alignment for component ii; and nn is the total number of components. In some embodiments, cultural context module 240 utilizes scoring, indicators, and thresholds to redefine the avatars (e.g., chatbots, etc.) in a given virtual environment, in which data associated with the redefining may be based on geographic location and interactions of user 270 within the virtual environment. Thus, allowing avatars to reflect the up-to-date cultural, social, etc. skills associated with the respective geographic location of the relevant virtual environment.

Computing device 260 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network or querying a database. It should be noted that in the instance in which computing device 260 is a CMR device (e.g., VR headset, AR goggles, smart glasses, etc.) or other applicable wearable device, computing device 260 is configured to collect sensor data via one or more associated sensor systems including, but are not limited to, cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IOT”) sensors, or any other applicable type of sensors known to those of ordinary skill in the art.

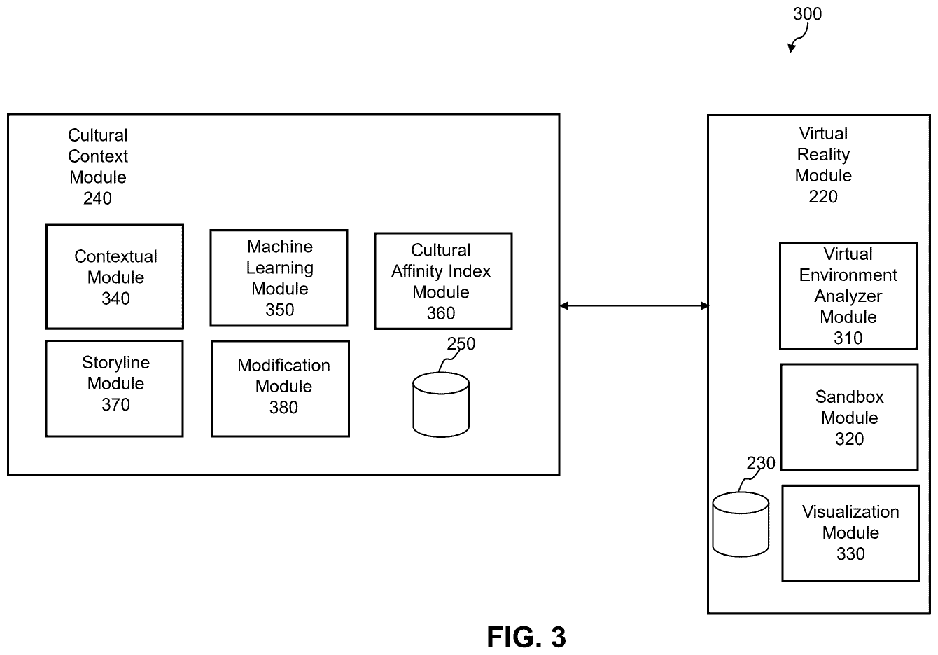

Referring now to FIG. 3, an example architecture 300 of virtual reality module 220 and cultural context module 240 is depicted, according to an exemplary embodiment. In some embodiment, virtual reality module 220 comprises a virtual environment analyzer module 310, a sandbox module 320, and a visualization module 330. Cultural context module 240 comprises a contextual module 340, a machine learning module 350, a Cultural Affinity Index (CAI) module 360, a storyline module 370, and modification module 380. Outputs of one or more machine learning models operated by machine learning module 350 are configured to be stored in one or more of database 215, virtual reality module database 230, and cultural context module database 250, in which the machine learning models may train datasets based on data derived from one or more of server 210, virtual reality module 220, cultural context module 240, and any other applicable data sources (e.g., internet-based data sources).

Virtual environment analyzer module 310 is configured to process and analyze an applicable virtual environment associated with user 270 in order to ascertain information regarding virtual elements of the virtual environment, other users, and the like. For example, virtual environment analyzer module 310 is configured to ascertain data associated with virtual environments including, but not limited to, regional/geographic-related data associated with applicable users (e.g., weather, clothing customs, etc.), avatar data, expertise data, share learning insights, reactions of user 270 to interactive patterns/virtual environment features, event data associated with events occurring within virtual environments (e.g., festivals, concerts, gatherings, etc.), and any other applicable ascertainable information associated with virtual environments known to those of ordinary skill in the art. Virtual environment analyzer module 310 may ascertain the aforementioned by communicating with machine learning module 350 to perform natural language processing (NLP)/linguistics processing, image analysis, video analysis, topic identification, virtual object recognition, setting/environment classification, computer vision, and any other applicable artificial intelligence and/or cognitive-based techniques known to those of ordinary skill in the art. For example, an applicable virtual environment may comprise a theme based on a popular festival associated with a cultural/geographic region that user 270 is familiar with. Virtual environment analyzer module 310 not only ascertains information derived from server 210 associated with the applicable geographic region relevant to the popular festival, but also the relevant and cultural and societal standards for the purpose of transmitting said information to cultural context module 240. In addition, virtual environment analyzer module 310 analyzes clothing, appearance, speech/dialects, etc. of other users within the applicable virtual environment for the purpose of user profiling by continuously monitoring interactions of users with the applicable virtual environment; thus, ultimately dynamically tailoring the VR experience to meet the specific needs and interests of user 270, ensuring a personalized learning experience.

Sandbox module 320 is tasked with rendering a virtual reality sandbox comprising one or more privatized virtual machines bundled in a network infrastructure configured to not only prevent accessibility to other users, but also isolate anomalies associated with the unsupervised machine learning performed by machine learning module 350. It should be noted that the virtual reality sandbox is designed to go beyond static simulations within virtual environments by dynamically adapting scenarios based on tracking and monitoring areas of focus and/or location/destination associated with user 270. In particular, the virtual reality sandbox takes into consideration cultural context ascertained by contextual module 340 in order for visualization module 330 to render virtual environments populated with avatars representing diverse cultural groups in a secure manner, in which sandbox module 320 is continuously checking for security vulnerabilities, threats/risks, and/or weaknesses potentially infiltrating one or more elements of system 200 (e.g., server 210, computing device 260, etc.).

Visualization module 330 is tasked with not only generating the virtual environments, but also the dynamic modifications applied to the virtual environments. In some embodiments, the dynamic modifications applied to the virtual environments are performed based on contextual information ascertained from cultural context module 240, in which visualization module 330 utilizes one or more generative adversarial networks (GANs) in order to tailor the virtual environment in a manner that meets the specific needs/interests user 270. In some embodiments, visualization module 330 utilizes feedback from user 270 in order to optimize the resulting visualizations for the purpose of tailoring the virtual environments according to the focus of user 270. Visualizations may comprise interactive animations, text displays, immersive dialogues, and any other applicable virtual element-based content configured to align with the needs/interests of user 270.

Contextual module 340 is designed to determine not only the context of a virtual environment, but also cultural norms associated with avatars and other users within the virtual applicable virtual environment in order for user 270 to navigate social nuances, communicate effectively, and exhibit culturally appropriate behaviors relating to the applicable geographic region. In some embodiments, context may be established by one or more of the virtual environment elements (e.g., setting, theme, virtual objects, geographic location, chatbots/avatars, etc.), dialogue among users and participating virtual elements (e.g., chatbots, instructions, etc.) within the virtual environment, linguistic inputs associated with user 270 (e.g., “I wonder if my attire is appropriate for this setting?”, etc.), transactions within the virtual environment, workflows occurring within the virtual environment, and the like. For example, contextual module 310 may ascertain the context of a virtual environment by analyzing applicable workflows in order to determine user 270 is suffering from a cultural deficiency or engaging in direct/indirect communications involving etiquette.

Context may further comprise cultural values, communication styles, social norms/etiquette, cultural sensitivity/adaptability, and the like. Contextual module 340 is further configured to perform correlation of actions of user 270 (e.g., gestures, speech, social media interactions, etc.) with empathy, cultural sensitivity, effective cross-cultural communication skills, etc. based on detected sentiment, aesthetics, etc. associated with the applicable virtual environment. For example, contextual module 340 may ascertain a cultural deficiency associated with user 270 based on detection of repulsion expressed by avatars derived from electromyography (i.e., other users expressing disapproval of an action of user 270).

Machine learning module 350 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. For example, machine learning module 350 is designed to maintain one or more machine learning models dealing with training datasets including data derived from the contextual information in order to generate predictions pertaining to cultural-related desires of user 270 (e.g., demand for knowledge regarding particular aspect of an unfamiliar culture, etc.), cultural deficiencies, and other applicable virtual elements to be integrated into a virtual environment. In some embodiments, machine learning module 350 performs federated learning, which is a process for using machine learning algorithms to train models without necessitating the training data to be stored in a central location, such as database 215. For example, machine learning module 350 may employ a federated learning process by training respective machine learning models based on confidential data sets. Machine learning module 350 may further share one or more derivatives of the trained models, such as model weights or gradients with respect to the data points, for aggregation purposes. In some embodiments, the one or more machine learning models are designed to train datasets comprising one or more of the contextual data, cultural-related data, sensor data, linguistic inputs of users, interactions associated with the virtual environment, and the like.

Cultural Affinity Index (CAI) module 360 is designed to assess the degree of cultural alignment or compatibility between user 270 and a given virtual environment including, but not limited to other users, virtual objects, settings, and the like. It should be noted that CAI module 360 assesses various dimensions of culture taking into consideration overt and subtle aspects that influence human interactions (e.g., dialogues, gestures, formalities, etc.) such as, but not limited to cultural values, communication styles, social norms/etiquette, cultural sensitivity/adaptability, and the like. In some embodiments, CAI module 360 calculates CAI via the following formula: CAIAB=Σi=1nWi·SiΣi=1nWiCAIAB=Σi=1nWΣi=1nWi·Si, in which the CAI comprises a plurality of parameters, weights (e.g., reflecting relative importance of each component to cultural compatibility), and scores relating cultural values, communication styles, social norms/etiquette, cultural sensitivity/adaptability associated with the given virtual environment. In some embodiments, the CAI value ranges from 0 to 1 in which the higher values indicate greater cultural affinity or compatibility between user 270 and other users and/or virtual elements of the virtual environment. In some embodiments, the calculated CAI value dictates the storyline generated by storyline module 370, in which storyline module 370 communicates with machine learning module 350 allowing outputs representing adaptations for cultural context understanding to be generated. For example, CAI module 360 may instruct large language models operated by machine learning module 350 to be fine-tuned for contextual comprehension in order to ascertain nuanced cultural nuances embedded within language for the purpose of being integrated into storylines generated by storyline module 370.

Storyline module 370 is configured to dynamically render multi-media content tailored based on one or more of contextual information, CAI value, and/or one or more outputs of the machine learning models operated by machine learning module 350. Storylines may comprise one or more cultural experiences, rituals, direct instruction, role modeling, media consumption, participatory community events, and any other applicable cultural related experience known to those of ordinary skill in the art. It should be noted that the storylines are a compilation of multi-media content visualized within the virtual environment that aim to align with cultural backgrounds, interests, and learning objectives of user 270 and/or virtual elements of a given virtual environment. For example, if it is ascertained that user 270 has one or more cultural deficiencies associated with a given virtual environment, then storyline module 370 utilizes GANs trained based on contextual information and outputs of the machine learning models to render adaptive storylines configured to interact with user 270 within the virtual environment in real-time. In some embodiments, storyline module 370 being in communication with sandbox module 320 allows for the storylines to be manifested in a manner that provides a rich array of cultural scenarios, stories, and dialogues tailored to the specific cultural contexts desired by user 270; thus, providing a dynamic and engaging learning experience. In particular, communications between storyline module 370 and sandbox module 320 allow dynamic adaptation of storytelling and scenario generation to align with cultural backgrounds, interests, and learning objectives of user 270, which ultimately enhances user engagement and effectiveness of cultural learning. For example, sandbox module 320 may instruct storyline module 370 to manage one or more interactive narrative-driven modules in the VR sandbox; thus, allowing user 270 to engage with culturally significant stories presented by avatars, chatbots, applicable virtual elements, and the like facilitating an immersive understanding of cultural norms and values associated with the applicable virtual environment. In some embodiments, the storylines are step-by-step interactive sessions within the VR environment that allow user 270 to participate in virtual rituals guided by culturally knowledgeable avatars trained based on one or more of contextual information, analyses performed by virtual environment analyzer module 310, relevant data acquired by server 210, CAI module 360, and the like.

Modification module 380 is designed to support the dynamic content generation and integration of the storylines in addition to scaling cultural contexts, languages, and preferences of user 270 for dynamic modifications to virtual environments tailored based on user 270. It should be noted that modification module 380 facilitates the dynamic modification of culturally diverse scenarios, storylines, and interactions within the virtual environment; thus, ensuring variety, novelty, and freshness in users' cultural learning experiences, enhancing retention and engagement. In particular, modification module 380 continuously integrates multimedia elements such as videos, images, audio clips, volumetric data, and the like within the VR scenarios in a sustainable manner that reduces the amount of otherwise necessary computing resources by partitioning media designed for the virtual environments and splicing storyline elements into the partitioned media based on outputs of the one or more machine learning models. For example, contextual information ascertained from a travel itinerary associated with user 270 allows for tailored content to be interlaced into an applicable storyline relating to user 270 that reflects the cultural context pertaining to the destination that user 270 is traveling to. As a result, modification module 380 splices relevant media content associated with the applicable geographic location into not only the given virtual environment (e.g., modification of virtual elements that align with marketplaces, corporate settings, social gatherings, etc. of the geographic location), but also a given storyline that is tailored to the itinerary.

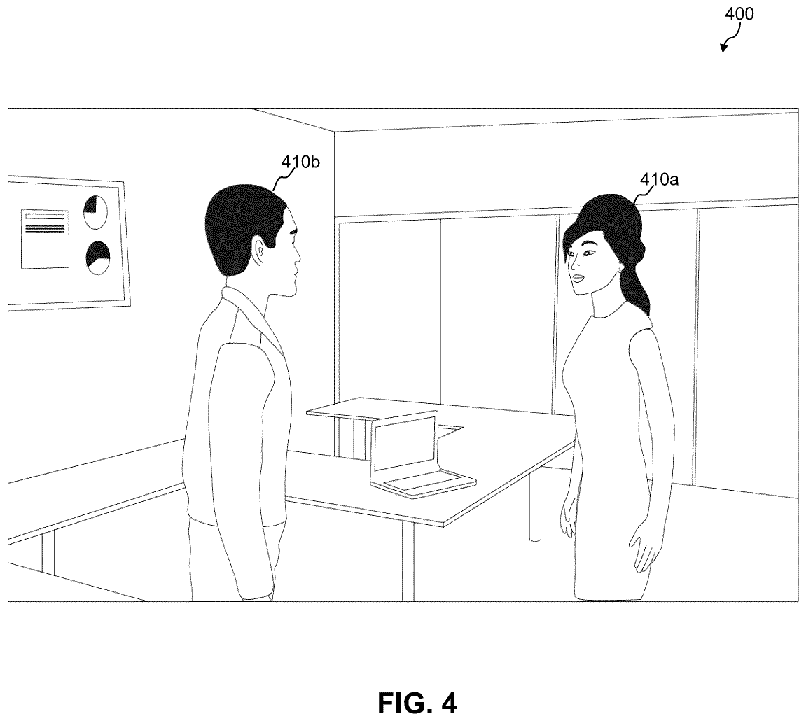

Referring now to FIG. 4, a dynamic virtual environment for cultural learning based on a first culture 400 is presented, according to an exemplary embodiment. Dynamic virtual environment 400 comprises one or more virtual avatars 410a & 410b; however in some embodiments, avatar 410 is associated with user 270 and avatar 410b is a virtual chatbot or the like. In the instances in which avatar 410b is a virtual chatbot, the virtual chatbot facilitates interactive dialogue with avatar 410 in order to ascertain user specific desires for storylines, preferences, and the like based on the contextual information established by cultural context module 240. For example, during dialogue between avatars 410a & 410b the virtual chatbot may ascertain from user 270 that user 270 desires to learn about garment for specific environments associated with a particular culture. As a result, the virtual chatbot utilizes natural language processing on the linguistic inputs of user 270 allowing cultural context module 240 to generate one or more outputs associated with cultural context, storylines, etc. based on at least one of ascertained contextual information, analyses performed by virtual environment analyzer module 310, relevant data acquired by server 210, CAI module 360, and the like. In some embodiments, the virtual chatbot may function as a mechanism for facilitating a feedback loop, in which the interactive dialogue ascertains feedback of user 270 relating to one or more of virtual environment visualizations, storylines, modifications, and the like. It should be noted that various data associated with user 270 is analyzed prior to the rendering of storylines including, but not limited to biological data (e.g., eye gaze/focus, pre-existing health conditions, allergies, etc.), user travel plans, interests, cultural gaps, and the like to ensure that user 270 receives storylines targeted towards cultural insights relevant to their specific needs.

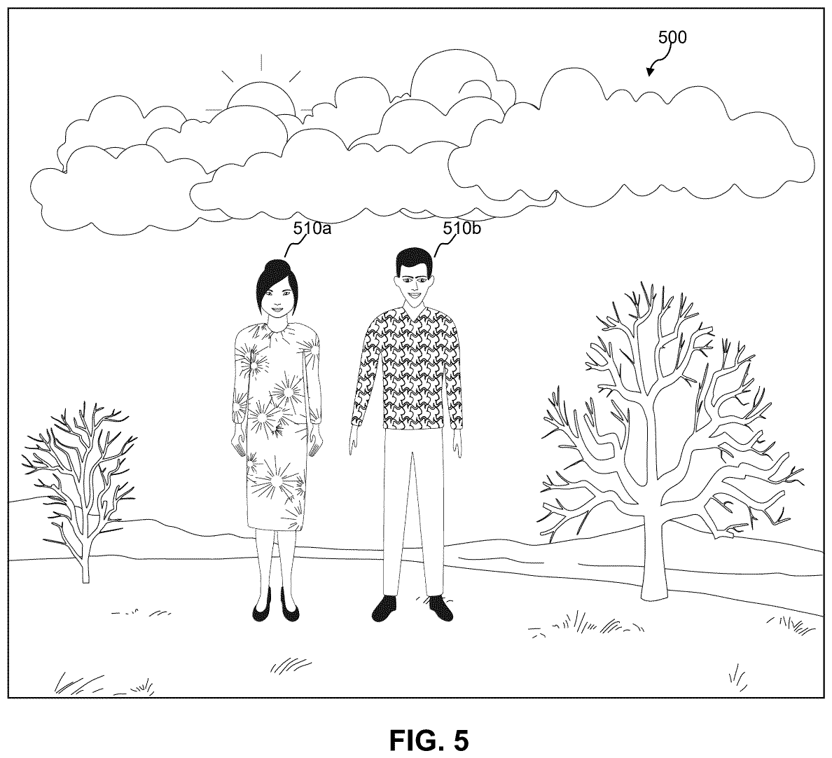

Referring now to FIG. 5, a dynamic virtual environment for cultural learning 500 comprising modifications is presented, according to an exemplary embodiment. It should be noted that the modifications to the virtual environments are dynamic and may be based on the ascertained contextual information and/or user 270 indicating they desire to learn a particular facet of culture and/or rectify a determined cultural gap. In this example, dynamic virtual environment 500 is rendered based upon a determination that user 270 has an upcoming business trip ascertained from the contextual information and/or server 210 (e.g., email platform, social media, etc.). As a result, user 270 is able to observe avatars 510a & 510b interacting with each other exchanging culture-specific languages/dialects, customs, etiquettes, gestures (e.g., bowing, handshakes, etc.), and the like. In a depicted simulation presented to user 270 in an applicable virtual environment, user 270 is in a business environment in the applicable geographic location in which user 270 attempts to shake the hand of avatars 510a & 510b; however, avatars 510a & 510b proceed to instruct user 270 about the cultural norm of bowing to greet resulting in a storyline being generated highlighting the history behind greetings, the correlation between greetings and the applicable geographic location, and the like. Avatars 510a & 510b may also assist and instruct regarding language/dialect, customs, gestures, etc. in which visualization module 330 may initiate a feedback loop in order to ascertain feedback from user 270 for optimization for future modifications to the storylines. In some embodiments, modification module 380 may make dynamic modifications to the virtual environment based on context derived from the interactions between user 270 and avatars 510a & 510b. For example in the instance in which user 270 says something that does not align with the cultural/societal norms of the applicable geographic location, modification module 380 modifies one or more virtual elements associated with the given virtual environment (e.g., change of outside weather from sunny to cloudy/ominous background, and the like) to reflect a cultural gap and/or point of contrast exists; thus, prompting an interactive dialogue between user 270 and the avatars are to why the statement does not align with the given culture.

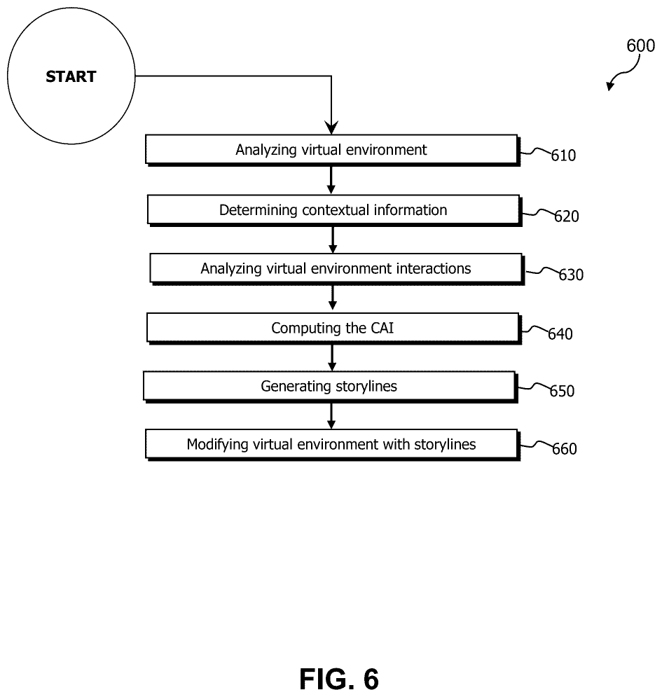

With the foregoing overview of the example architecture, it may be helpful now to consider a high-level discussion of an example process. FIG. 6 depicts a flowchart illustrating a computer-implemented process 600 for creating dynamic virtual environments for cultural learning, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, virtual environment analyzer module 310 performs analyses on the virtual environment and its components. Virtual environment analyzer module 310 may utilize NLP, image analysis, topic identification, virtual object recognition, setting/environment classification, and any other applicable artificial intelligence and/or cognitive-based techniques known to those of ordinary skill in the art. In addition, relevant data associated with user 270 is being collected in order to ascertain contextual information associated with a given virtual environment in order to optimize the modifications and storylines subsequently integrated into the virtual environment. For example, a travel itinerary associated with user 270 and/or other relevant information associated with user 270 (e.g., social media information, interests, biological data, and the like) may to ascertained in order to guide preferences, visualizations, relevant geographic location culture, etc. for the generated virtual environments.

At step 620 of process 600, contextual module 340 determines the context associated with a given virtual environment in addition to the intentions/purpose user 270 is engaging with the virtual environment. Context may be established by one or more of the virtual environment elements (e.g., setting, theme, virtual objects, geographic location, chatbots/avatars, etc.), dialogue among users and participating virtual elements (e.g., chatbots, instructions, etc.) within the virtual environment, linguistic inputs associated with user 270 (e.g., “I wonder if my attire is appropriate for this setting?”, etc.), transactions within the virtual environment (e.g., purchases, desires to learn about something, queries, etc), workflows occurring within the virtual environment, and the like. It should be noted that one of the purposes of ascertaining context is to determine how virtual environments, virtual elements, storylines, and the like are to be tailored in accordance with user 270.

At step 630 of process 600, CAI module 360 ascertains and analyzes interactions with a given virtual environment. In some embodiments, CAI module 360 communicates with virtual environment analyzer module 310 and contextual module 340 in order to ascertain data associated with user 270 and the virtual environment including, but not limited to tracking and monitoring user focus, user desires, preferences, etc. for the purpose of computing scores relating cultural values, communication styles, social norms/etiquette, cultural sensitivity/adaptability associated with the given virtual environment. In some embodiments, the CAI value ranges from 0 to 1 in which the higher values indicate greater cultural affinity or compatibility between user 270 and other users and/or virtual elements of the virtual environment. CAI values may also be utilized in the modification process in which the VR sandbox provides an adaptive learning experience tailored specifically for user 270 in a dynamic manner.

At step 640 of process 600, CAI module 360 computes the CAI. As previously mentioned, the CAI is configured to capture the nuances of cultural differences and similarities in a systematic and comprehensive manner by applying one or more formulas incorporates various dimensions of culture, considering both overt and subtle aspects that influence human interactions including, but not limited to cultural values, communication styles, social norms and etiquette, cultural sensitivity/adaptability, and the like. In some embodiments, CAI module 360 computes the CAI between user 270 and a virtual element associated with a virtual environment rendered based on a geographic location user 270 wishes to learn about (e.g., an upcoming trip destination). CAI=CAIAB=Σi=1nWi·SΣi=1nWiCAIAB=Σi=1nWiΣi=1nWi·Si, in which CAIABCAIAB is the CAI between individuals/groups A and B (i.e., user 270 and applicable virtual element); WiWi is the weight assigned to component ii; SiSi is the score representing the degree of alignment for component ii; and nn is the total number of components. Cultural context module 240 utilizes scoring, indicators, and thresholds to redefine virtual elements in the given virtual environment, in which data associated with the redefining may be based on geographic location, interactions of user 270 within the virtual environment/elements, privacy data relevant to sandbox module 320, and the like.

At step 650 of process 600, storyline module 370 generates the storyline(s) for presentation to user 270 within the given virtual environment. In some embodiments, a storyline initiates one or more modifications to the virtual environment that identifies gaps between user 270, their own culture, and the applicable destination culture along with gaps associated with the computed CAI. Ultimately, storyline module 370 generates one or more storylines that enable user 270 to gain nuanced understanding of cultural differences and similarities via interactive virtual elements, cultural exercises, and the like. For example, storyline module 370 renders a virtual office setting in Tokyo comprising avatars representing local Japanese business professionals as colleagues, in. which user 270 observes interactions between the avatars noting their greeting customs (e.g., bowing), formal language usage, meeting etiquettes, etc. User 270 decides to engage in the simulated business meeting, in which a gesture to inadvertently extend their hand for a handshake (instead of bowing) is gently corrected by the avatar and subsequent guidance to bow is respectfully provided. Simultaneously, contextual module 340 notices user 270 focusing on negotiation tactics; thus, storyline module 370 instructs modification module 380 that modifications are warranted.

At step 660 of process 600, modification module 380 renders modifications to the virtual environment via storylines. Continuing on the previous example, modification module 380 renders and integrates storylines where Japanese avatars demonstrate indirect communication styles and consensus-building techniques prevalent in Japanese business culture, in which modification module 380 generates the modifications based on one or more contextual information, interactions among virtual elements within the virtual environment, and the like. Furthermore, modification module 380 is configured to generate subsequent modifications based on user feedback, recently news (e.g., headlines, weather, etc.), derivatives of linguistic inputs, and the like. For example, modification module 380 may render a modifying storyline highlighting the importance of gift-giving in Japanese business culture. Thus, the modifying storyline comprises avatars enacting an interactive scene where a small, well-wrapped gift is exchanged explaining its significance and proper etiquette. Subsequently, modification module 380 utilizes contextual information and user feedback mechanisms to refine storylines and splice media content into storylines integrated at optimal memory spaces (e.g., determined based on outputs of the machine learning models) to address any remaining gaps in cultural understanding; thus, ensuring user 270 is prepared for their upcoming experience. In addition, modifications may be based on analyses derived from the tracking and monitoring of user area of focus.

Based on the foregoing, a method, system, and computer program product have been disclosed. However, numerous modifications and substitutions can be made without deviating from the scope of the present invention. Therefore, the present invention has been disclosed by way of example and not limitation.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

1. A computer-implemented method for dynamically creating virtual learning environments, the method comprising:
analyzing, by a computing device, a virtual environment and a plurality of users associated with the virtual environment to ascertain a virtual environment theme;
determining, by the computing device, a cultural gap within the virtual environment derived from analysis of a plurality of contextual information based on respective geographic locations of the plurality of users and the virtual environment theme; and
adjusting, by the computing device, the virtual environment in a virtual reality sandbox based on utilizing a computed Cultural Affinity Index (CAI) value associated with the cultural gap;
wherein adjusting comprises monitoring a plurality of interactions of the plurality of users with the virtual environment based on the plurality of contextual information and fine-tuning at least one large language model (LLM) to adjust the virtual environment based on the CAI value.

2. The computer-implemented method of claim 1, wherein monitoring the plurality of interactions further comprising:
generating, by the computing device, a plurality of cultural-based avatars based on the contextual information;
wherein the plurality of cultural-based avatars are configured to engage with the plurality of users within the virtual environment.

3. The computer-implemented method of claim 2, wherein the plurality of cultural-based avatars generate one or more cultural-related dialogues associated with learning objectives or interests associated with the plurality of users and analyze the responses to cultural-related dialogues for adjusting the virtual environment.

4. The computer-implemented method of claim 1, wherein the adjusted virtual environment is a virtual sandbox infrastructure comprising a plurality of privatized virtual machines.

5. The computer-implemented method of claim 2, wherein monitoring the plurality of interactions comprises:
tracking and analyzing, by the computing device, one or more areas of focus associated with the plurality of users; and
modifying, by the computing device, the plurality of cultural-based avatars based on the analysis.

6. The computer-implemented method of claim 1, wherein adjusting the virtual environment further comprises:
utilizing, by the computing device, one or more machine learning models to generate a cultural-based story depicted within the virtual environment based on the plurality of contextual information.

7. The computer-implemented method of claim 1, wherein the plurality of contextual information comprises one or more cultural and societal customs associated with the geographic locations of the plurality of users.

8. A computer program product for dynamically creating virtual learning environments, the computer program product comprising or more computer readable storage media and program instructions collectively stored on the one or more computer readable storage media, the stored program instructions comprising:
program instructions to analyze a virtual environment and a plurality of users associated with the virtual environment to ascertain a virtual environment theme;
program instructions to determine a cultural gap within the virtual environment derived from analysis of a plurality of contextual information based on respective geographic locations of the plurality of users and the virtual environment theme; and
program instructions to adjust the virtual environment in a virtual reality sandbox based on utilizing a computed Cultural Affinity Index (CAI) value associated with the cultural gap;
wherein program instructions to adjust comprise program instructions to monitor a plurality of interactions of the plurality of users with the virtual environment based on the plurality of contextual information and fine-tune at least one large language model (LLM) to adjust the virtual environment based on the CAI value.

9. The computer program product of claim 8, wherein program instructions to monitor the plurality of interactions further comprise:
program instructions to generate a plurality of cultural-based avatars based on the contextual information;
wherein the plurality of cultural-based avatars are configured to engage with the plurality of users within the virtual environment.

10. The computer program product of claim 9, wherein the plurality of cultural-based avatars generate one or more cultural-related dialogues associated with learning objectives or interests associated with the plurality of users and analyze the responses to cultural-related dialogues for adjusting the virtual environment.

11. The computer program product of claim 8, wherein the adjusted virtual environment is a virtual sandbox infrastructure comprising a plurality of privatized virtual machines.

12. The computer program product of claim 9, wherein program instructions to monitor the plurality of interactions further comprise:
program instructions to track and analyze one or more areas of focus associated with the plurality of users; and
program instructions to modify the plurality of cultural-based avatars based on the analysis.

13. The computer program product of claim 8, wherein program instructions to adjust the virtual environment further comprise:
program instructions to utilize one or more machine learning models to generate a cultural-based story depicted within the virtual environment based on the plurality of contextual information.

14. The computer program product of claim 8, wherein the plurality of contextual information comprises one or more cultural and societal customs associated with the geographic locations of the plurality of users.

15. A computer system for dynamically creating virtual learning environments, the computer system comprising:
one or more processors;
one or more computer-readable memories;
program instructions stored on at least one of the one or more computer-readable memories for execution by at least one of the one or more processors, the program instructions comprising:
program instructions to analyze a virtual environment and a plurality of users associated with the virtual environment to ascertain a virtual environment theme;
program instructions to determine a cultural gap within the virtual environment derived from analysis of a plurality of contextual information based on respective geographic locations of the plurality of users and the virtual environment theme; and
program instructions to adjust the virtual environment in a virtual reality sandbox based on utilizing a computed Cultural Affinity Index (CAI) value associated with the cultural gap;
wherein program instructions to adjust comprise program instructions to monitor a plurality of interactions of the plurality of users with the virtual environment, fine-tuning at least one large language model (LLM) to adjust the virtual environment based on the CAI value, and splicing media content associated with the virtual environment theme tailored to at least one user of the plurality of users into the virtual environment based on the plurality of contextual information and respective geographic location of the at least one user.

16. The computer system of claim 15, wherein program instructions to monitor the plurality of interactions further comprise:
program instructions to generate a plurality of cultural-based avatars based on the contextual information;
wherein the plurality of cultural-based avatars are configured to engage with the plurality of users within the virtual environment.

17. The computer system of claim 16, wherein the plurality of cultural-based avatars generate one or more cultural-related dialogues associated with learning objectives or interests associated with the plurality of users and analyze the responses to cultural-related dialogues for adjusting the virtual environment.

18. The computer system of claim 16, wherein program instructions to monitor the plurality of interactions further comprise:
program instructions to track and analyze one or more areas of focus associated with the plurality of users; and
program instructions to modify the plurality of cultural-based avatars based on the analysis.

19. The computer system of claim 15, wherein program instructions to adjust the virtual environment further comprise:
program instructions to utilize one or more machine learning models to generate a cultural-based story depicted within the virtual environment based on the plurality of contextual information.

20. The computer system of claim 15, wherein the plurality of contextual information comprises one or more cultural and societal customs associated with the geographic locations of the plurality of users.
